(19) United States
(12) Patent Application Publication
(10) Pub. No.: US 2013/0316677 A1
(43) Pub. Date: Nov. 28, 2013

(54) METHOD AND SYSTEM FOR ENTERPRISE RECORDING OF CELLULAR DEVICE COMMUNICATIONS

(71) Applicant: Boomering Communication (2005) Ltd., Netanya (IL)

(72) Inventor: Avihai AHARON, Netanya (IL)

(73) Assignee: BOOMERING COMMUNICATION (2005) LTD., Netanya (IL)

(21) Appl. No.: 13/900,567

(22) Filed: May 23, 2013

Related U.S. Application Data
(60) Provisional application No. 61/688,873, filed on May 24, 2012.

(51) Int. Cl. H04W 12/02

(52) U.S. Cl. CPC H04W 12/02
USPC 455/411

(57) ABSTRACT

A system and method for providing recording services for communications to or from at least one Enterprise Mobile Device (EMD), the system including an Enterprise Compliance Server (ECS) and an Enterprise Recording System (ERS). The ECS receives a Enterprise Mobile Device (EMD) communication request through a signaling channel from a Mobile Network Operator (MNO) upon an initiation of an EMD communication. The ECS then authenticates the EMD communication request, receiving an EMD communication. The ECS then sends the EMD communication to the ERS and the ERS is records the communication. If the communication is a voice call the ECS then conferences the call to an Enterprise Customer (EC).

### FIELD AND BACKGROUND OF THE INVENTION

The present invention relates to recording of communications made by a mobile device operable over cellular networks and, more particularly, to the secure recording by an enterprise recording system located within the enterprise premises of voice, text messages (e.g. Short Message Service SMS) and data communications to and from the mobile device.

As technology develops, individuals, enterprises and their customers expect to be able to take advantage of all available communication methods, which they are familiar with using in the office and in their personal lives. Enterprises, and their employees, increasingly rely on mobile communication devices and require mobile voice, text message and data recording services to carry out day-to-day business. For example, doctors require recording of out-of-hours calls with patients, sales staff require recording of verbal orders whilst on the road and text messing is now seen as a mainstream tool both in business and personal communication.

However, because historically mobile communication could not be recorded in an orderly and secure fashion, many organizations have “locked down” their corporate mobile devices so that messaging services (for example) cannot be accessed by their users.

The financial services industry is regulated in many countries and is generally required to record business calls made over fixed lines. Lately new legislation has come into force in many countries extending this requirement to mobile electronic communications such as voice, text messages and data e.g. the Dodd-Frank Wall Street Reform and Consumer Protection Act in the USA signed into law Jul. 21, 2010, and MiFID II adopted in Europe on the 20 Oct. 2011.

There are various current mobile communication recording solutions including application based solutions, cloud based solutions and forking solutions.

Application based communication recording where a software application is installed on the mobile device is unsatisfactory for a number of reasons. The application must be designed for compatibility with each mobile device operating system and the application must be installed and maintained on each mobile device. A further disadvantage of application based communication recording is that this technology relies on communications using the data service of the mobile carrier.

Cloud based solutions where the mobile network operator independently records and stores communications suffer from security issues and reduced control of recorded data by the enterprise.

Forking solutions where the mobile network operator routes the call to the enterprise for recording, through, for example, a SIP (Session Initiation Protocol) trunk which lacks the necessary security thus requiring both the enterprise and mobile network operator to invest in infrastructure to ensure the connection between the MNO and enterprise is secure.

It would therefore be highly advantageous to have a method and system offering secure enterprise-based recording of mobile electronic communications.

### SUMMARY OF THE INVENTION

According to the present invention there is provided a communication system which provides recording services for communications to or from at least one Enterprise Mobile Device (EMD), the system including: (a) an Enterprise Compliance Server (ECS); and (b) an Enterprise Recording System (ERS); wherein the ECS is operative to receive a EMD communication request through a signaling channel from a Mobile Network Operator (MNO) upon MNO receipt of an EMD communication initiation; wherein upon the receipt of the EMD communication request the ECS is operative to authenticate the EMD communication request; wherein upon the authentication the ECS is operative to receive an EMD communication; wherein the ECS is operative to send the EMD communication to the ERS; wherein the ERS is operative to record the communication.

According to the present invention there is provided a Subscriber Identity Module (SIM) card including a memory wherein is stored: (a) a SIM Toolkit (STK) application; wherein: (ii) the STK application is operative to select a cellular device signaling protocol.

According to the present invention there is provided a Subscriber Identity Module (SIM) card including a memory wherein is stored: (a) a plurality of IMSI numbers; (b) a SIM Toolkit (STK) application that is operative to select an IMSI number.

According to the present invention there is provided a Mobile Network Operator (MNO) which provides communication services to at least one Enterprise Mobile Device (EMD) wherein in response to receipt of an EMD communication initiation the MNO is operative to recognize that the communication initiation is from an EMD; wherein in response to the recognition the MNO is operative to send a communication request through a signaling channel to an enterprise; wherein in response to receipt of an authentication of the communication request the MNO is operative to send an EMD communication to the enterprise.

According to the present invention there is provided a communication services method for an enterprise the method including the steps of: (a) receiving an Enterprise Mobile Device (EMD) communication request through a signaling channel; (b) authenticating the communication request; (c) in response to the authenticating, receiving an EMD communication.

According to the present invention there is provided a method which provides communication services to an Enterprise Mobile Device (EMD), the method including the steps of: (a) installing, in the EMD, a SIM card comprising a memory wherein is stored: (i) a SIM Toolkit (STK) application including a signaling protocol guide; (b) by the STK; (i) selecting a cellular device signaling protocol.

According to the present invention there is provided a method which provides communication services to an Enterprise Mobile Device (EMD), the method including the steps of (a) installing, in the EMD, a SIM card comprising a memory wherein is stored: (i) a plurality of IMSI numbers; (ii) a SIM Toolkit (STK) application; (b) by the STK; (i) selecting an IMSI number.

According to the present invention there is provided a method which provides communication services between an Enterprise Mobile Device (EMD) and an enterprise at a Mobile Network Operator (MNO) server, the method including the steps of: (a) receiving an EMD communication initiation; (b) sending an EMD communication request to the enterprise through a signaling channel; (d) upon receiving an EMD communication authentication from the enterprise: sending an EMD communication to the enterprise.

One basic system of the present invention, for providing recording services for communications to or from at least one Enterprise Mobile Device (EMD), includes an Enterprise Compliance Server (ECS) and an Enterprise Recording System (ERS). The ECS receives a EMD communication request through a signaling channel from a Mobile Network Operator (MNO) upon MNO receipt of an EMD communication initiation. The ECS then authenticates the EMD communication request, receiving an EMD communication. The ECS then sends the EMD communication to the ERS and the ERS records the communication.

Preferably, the signaling channel is a secure signaling channel and the ECS receives the EMD communication request from the MNO through an ECS input/output port by a communication channel.

In some embodiments the system further includes a Private Branch Exchange (PBX). Then, if the EMD communication is a voice call then the ECS receives the EMD communication through the PBX.

In one embodiment, if the EMD communication is an outgoing voice call via a direct dialing communications protocol then when the ECS receives the EMD communication request the ECS authenticates the communication request by sending the MNO an enterprise telephone number through the signaling channel and the ECS receives the EMD communication from the MNO by answering a call to the enterprise telephone number. Then the ECS connects the EMD communication to an Enterprise Customer (EC) by conferencing an EC number. Preferably, the system further includes a PBX and the enterprise telephone number is a Direct Inward Dialing (DID) number and the ECS receives the EMD communication via DID to the PBX and connection of the EMD communication to the EC is through the PBX.

In one embodiment, if the EMD communication is an outgoing call in a call-back mode or an incoming call then when the ECS receives the EMD communication request the ECS authenticates and receives the EMD communication via dialing an EMD number and the ECS conferences the EMD communication to an Enterprise Customer (EC) by dialing an EC number. Preferably, the system further includes a PBX, dialing of the EMD and EC numbers is through the PBX.

In one embodiment, if the EMD communication is a text message or an EMD data communication then the ECS receives the EMD communication through the signaling channel.

In some embodiments, the ECS receives a metadatum from the MNO through the signaling channel and the ECS sends the metadatum to the ERS. The ERS then records the metadatum with the EMD communication.

In some embodiments, the ECS includes a policy manager. The policy manager checks if the EMD communication is to or from a number on a white-list. If the EMD communication is not to or from a number on a white-list the ERS records the EMD communication.

A Subscriber Identity Module (SIM) card of the invention includes a SIM Toolkit (STK) application. The STK application, when a cellular device which includes the SIM card is switched on, can select a cellular device signaling protocol. Preferably, the signaling protocol is Customized Applications for Mobile networks Enhanced Logic (CAMEL) or Unstructured Supplementary Service Data (USSD).

A Subscriber Identity Module (SIM) card of the invention includes a plurality of International Mobile Subscriber Identity (IMSI) numbers and a SIM Toolkit (STK) application. The STK application, when a cellular device which includes the SIM card is switched on, can select a IMSI number.

A Mobile Network Operator (MNO) of the present invention provides communication services to or from at least one Enterprise Mobile Device (EMD). When the MNO receives a EMD communication initiation the MNO recognizes that the communication initiation is from an EMD and sends a communication request through a signaling channel to an enterprise. When the MNO receives an authentication of said communication request from the enterprise the MNO is then sends an EMD communication to the enterprise.

Preferably, the communication request is sent by Hypertext Transfer Protocol (HTTP) and Hypertext Transfer Protocol Secure (HTTPS).

In one embodiment the EMD communication initiation is received via Signaling System 7 (SS7) protocol.

In one embodiment, if the EMD communication is an outgoing voice call via a direct dialing communications protocol then the authentication of the communication request includes an enterprise telephone number and the MNO sends the EMD communication to the enterprise by connecting the EMD voice call to the enterprise telephone number. Preferably, the enterprise telephone number is a DID number on an enterprise PBX and the MNO connects the voice call to the enterprise PBX by DID.

In one embodiment, if the EMD communication is an outgoing call in a call-back mode or an incoming call then the MNO sends the EMD communication to the enterprise by connecting a call from the enterprise to the EMD.

In one embodiment, if the EMD communication is a text message or an EMD data communication then the MNO sends the EMD communication to the enterprise through the signaling channel.

The scope of the present invention also includes the methods used by the system for recording communications to or from at least one Enterprise Mobile Device (EMD).

The scope of the present invention also includes the methods used by the Mobile Network Operator (MNO) for providing communication services to at least one Enterprise Mobile Device (EMD).

The scope of the present invention also includes the methods used by the SIM card for providing communication services to at least one Enterprise Mobile Device (EMD).

### GLOSSARY

API—Application Interface: a protocol intended to be used as an interface by software components to communicate with each other.
APN—Access Point Name: is the name of a gateway between a mobile network and another computer network, frequently the public Internet.
BRI—Basic Rate Interface is an Integrated Services Digital Network (ISDN) configuration intended primarily for use in subscriber lines similar to those that have long been used for plain old telephone service.
BSC—Base Station Controller: a component of an MNO which controls one or more BTSs and transfers the wireless communications from the BTS(s) to a MSC.
BTS—Base Transceiver Station: a component of a MNO which transfers wireless communication of a device to a BSC.
CAMEL—Customized Applications for Mobile networks Enhanced Logic: is a direct dialing communications protocol designed to work on either a GSM (Global System for Mobile Communications) network or a UMTS (Universal Mobile Telecommunications System) network.
DID—Direct Inward Dialing: a feature offered by telephone companies for use with a PBX. The telephone company allocates several telephone numbers to the PBX. When one of these numbers receives a call via DID the PBX directs the call to the correct internal extension.
E1—a digital carrier signal as defined by the European telecommunications standard.
EC—Enterprise Customer: a communication device used by a customer of an enterprise or the individual using the device. The EC is the device or individual with which an EMD communicates.
ECS—Enterprise Compliance Server: a server located within an enterprise premises or directly under the control of an enterprise able to control communications to and from an EMD.
EMD—Enterprise Mobile Device: a mobile communication device used by an employee of the enterprise
FXO—Foreign Exchange Office: a type of port used by analog phone lines.
FXS—Foreign Exchange Subscriber: a type of port used by analog phone lines.
HTTP—Hypertext Transfer Protocol: an application layer protocol for communications over an Internet Protocol computer network.
HTTPS—Hypertext Transfer Protocol Secure: an application layer protocol for communications over an Internet Protocol computer network.
ICCID—Integrated Circuit Card Identifier: a unique SIM card identification number.
IMSI—International Mobile Subscriber Identity: a unique SIM card identification number which is associated with all cellular networks.
LAN—Local Area Network: is a computer network that connects components e.g. computers and servers in a locality e.g. office building, enterprise, school.
MCC—Mobile Country Code: a number for uniquely identifying a mobile phone operator/carrier.
MNC—Mobile Network Code: a number for uniquely identifying a mobile phone operator/carrier.
MNO—Mobile Network Operator: a provider of wireless communications services owning or controlling all the elements necessary to sell and deliver mobile communication services to an end user.
MSC—Mobile Switching Center: a component of a MNO which carries out call switching and mobility management functions for mobile phones roaming on the network of base stations.
MSISDN—Mobile Station International Subscriber Directory Number: a number uniquely identifying a subscription in a mobile network. The MSISDN is used for routing calls to the mobile phone subscriber.
MSRN—Mobile Subscriber Roaming Number: a temporary mobile number allocated for a call in a registered mobile network.
PBX—Private Branch Exchange: a telephone exchange that serves a particular enterprise, business or office.
PSTN—Public Switched Telephone Network: is the network of the world's public circuit-switched telephone networks. It consists of telephone lines, fiber optic cables, microwave transmission links, cellular networks, communications satellites, and undersea telephone cables, all inter-connected by switching centers, thus allowing any telephone in the world to communicate with any other.
SIP—Session Initiation Protocol: a signaling protocol for controlling communications over Internet Protocol (IP).
SIM card—Subscriber Identity Module card: is an integrated circuit for use in a mobile device that at least stores a International Mobile Subscriber Identity (IMSI) number and a related key.
T1—a digital carrier signal, usually used in the USA.
TLS—Transport Layer Security: is a cryptographic protocol able to provide communication security over the Internet.
SSL—Secure Sockets Layer: is a cryptographic protocol able to provide communication security over the Internet.
USSD—Unstructured Supplementary Service Data: is a communications protocol used by cellular telephones operating using a GSM (Global System for Mobile Communications) network to communicate with the service provider's computers.
VPN—Virtual Private Network: Extension of a private network across public networks like the Internet by establishing a virtual point-to-point connection through the use of dedicated connections and/or encryption.
WAF—Web Application Firewall: is a is a form of firewall which controls input, output, and/or access from, to, or by an application or service.

### DEFINITIONS

The terms “short message service”, “SMS” and “text message” are used interchangeably to refer to a one way datum (e.g. text, image, video) communication sent from one device to another over a cellular network.

The terms “communication” and “media” are interchangeably used and are herein defined as referring to a voice call or text message or data communication to or from a device. For example the term “EMD communication” refers to a voice call or text message or data communication to or from the EMD.

“An “EMD data communication” is herein defined as the transfer of data to and from the EMD associated with the EMD use of internet or data services e.g. internet browsing, email, online gaming, sending and receiving videos, watching movies via, for example; GPRS (General packet radio service), EDGE (Enhanced Data Rates for GSM Evolution), 3G, 4G, LTE (Long Term Evolution), WiMAX (Worldwide Interoperability for Microwave Access) etc.

A “communication initiation” is herein defined as the signal received by a MNO when the user of a cellular device dials a number, attempts to send a text message or attempts to access data services. The MNO can receive a communication initiation from a cellular device (an EMD or an EC) or, when a cellular device is in a roaming mode, from a visited MNO. For example, a “communication initiation” is passed to a MNO when an Enterprise Mobile Device (EMD) dials a number, attempts to send a text message or attempts to access data services or when an Enterprise Customer (EC) dials an EMD or attempts to send a text message to an EMD. A communication initiation can be, for example a USSD message, a CAMEL protocol message etc.

The term “signaling based” with regards to communication initiations is herein defined as referring to communication initiations via signaling protocols (e.g. CAMEL and USSD) and is used to differentiate from other technologies which operate using data-based communication initiations using a MNO's data service (e.g. by using 3G).

The terms “outbound” and “inbound” are herein defined as referring to communications from and to an EMD respectively.

The term “EMD number” is herein defined as a number which can be used for routing a call to an EMD cellular device e.g. a MSRN number, a MSISDN number etc.

The term “EC number” is herein defined as a number which can be used for routing a call to an EC e.g. standard telephone number, MSRN number, MSISDN number etc.

The terms “metadatum” and “metadata” are herein defined as a datum or data associated with a communication, but not the communication itself, examples include; the direction of the call (inbound or outbound), the EMD telephone number, the EC number, the communication time and date, etc.

The term “conference” is herein defined as referring to the passing, dialing or connecting of a voice call to a destination when the call is concurrently being passed to at least one other destination. For example, in the context of embodiments of the present invention, the ECS can conference a call both to the ERS and the EC, the ECS can also conference a call to the ERS, EC and EMD.

### BRIEF DESCRIPTION OF THE DRAWINGS

Various embodiments are herein described, by way of example only, with reference to the accompanying drawings, wherein:

FIG. 1 is a simplified block diagram of a cellular communication recording system, according to an embodiment of the present invention;

FIG. 2 is a simplified block diagram of an embodiment of an enterprise hardware of the invention;

FIG. 3 is a simplified block diagram of a cellular communication recording system, operating in roaming mode, according to an embodiment of the present invention;

FIG. 4 illustrates an outbound call made in a direct dialing CAMEL (Customized Applications for Mobile networks Enhanced Logic) mode;

FIG. 5 illustrates an outbound call made in a USSD (Unstructured Supplementary Service Data) roaming mode;

FIG. 6 illustrates a CAMEL mode callback call;

FIG. 7 illustrates an incoming call;

FIG. 8 illustrates an outbound SMS;

FIG. 9 illustrates an inbound SMS;

FIG. 10 illustrates a data communication;

FIG. 11 illustrates a high-level partial block diagram of an exemplary Enterprise Compliance Server (ECS);

FIG. 12 illustrates a high-level partial block diagram of an exemplary Subscriber Identity Module (SIM) card;

FIG. 13 illustrates a high-level partial block diagram of an exemplary Mobile Network Operator (MNO);

FIG. 14 illustrates a high-level partial block diagram of an exemplary MNO server.

### DESCRIPTION OF THE PREFERRED EMBODIMENTS

The principles and operation of a system and method of secure on premises network based mobile communication recording according to the present invention may be better understood with reference to the drawings and the accompanying description.

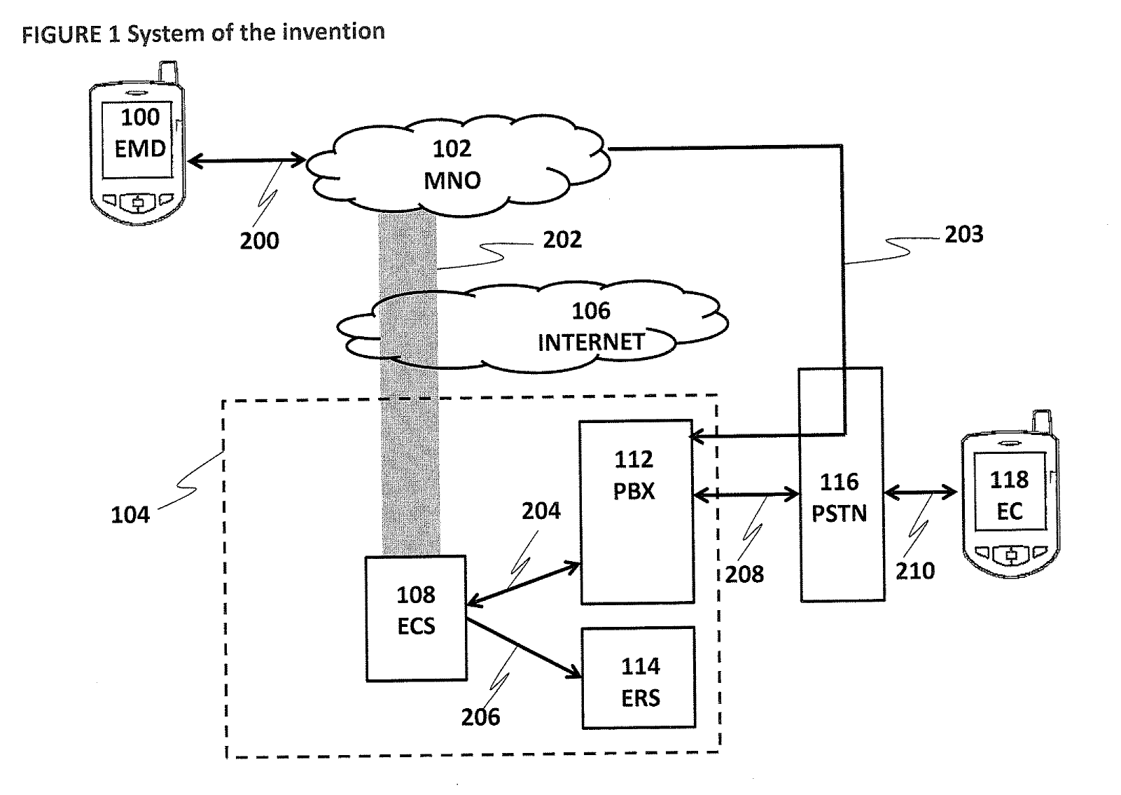

Referring now to the drawings, FIG. 1 illustrates an embodiment of the system of the invention. In FIG. 1 Enterprise Mobile Device (EMD) 100 is a communication device used by an enterprise employee which communicates with a Mobile Network Operator (MNO) 102 via a connection 200. Enterprise hardware 104 includes an Enterprise Compliance Server (ECS) 108, a Private Branch Exchange (PBX) 112, and an Enterprise Recording System (ERS) 114. MNO 102 connects to enterprise hardware 104 at two points; communicating with ECS 108 through a signaling channel 202 (via the internet 106) and connecting to PBX 112 through a call channel 203. ECS 108 is connected to PBX 112 and ERS 114 through connections 204 and 206 respectively. PBX 112 is connected by a connection 208 to a Public Switched Telephone Network (PSTN) 116. PSTN 116 is connected by a connection 210 to an Enterprise Customer (EC) 118, a communication device used by a customer of the enterprise or other individual or device with which an enterprise employee using an EMD communicates with. In the case that EC 118 is a mobile device connection 210 includes an EC MNO.

The system architecture illustrated in FIG. 1 is intended to be exemplary only, and the actual system architecture will depend on the services, functionality, security, redundancy and scalability desired by the enterprise.

Although, within this document, description is with reference to one EMD and one enterprise it is to be understood that generally more than one EMD is associated with an enterprise and that the system can be implemented for more than one enterprise and with more than one MNO (e.g. an enterprise can have more than one signaling channel each connected to a different MNO).

Referring to the embodiment of FIG. 1, enterprise hardware 104 includes ECS 108, PBX 112, ERS 114, and associated interconnections. The enterprise hardware can also include other optional elements, for example a media server, a gateway and a Session Border Controller (SBC) as are known in the art. Enterprise hardware 104 can be located in the enterprise premises or other secure location under the control of the enterprise, such as a data center, and the enterprise hardware is typically housed in a single building, however distributed architectures are also contemplated and encompassed by the present invention. Although FIG. 1 shows separate and distinct devices, in other embodiments of the invention the various components of the enterprise hardware can be integrated in many ways, as is well known in the art. For example two or more of the described components (e.g. ECS and ERS) can be integrated into a single device, or can be integrated into a PBX.

Mobile Network Operator (MNO) 102 also termed wireless service provider, wireless carrier or cellular company can be any provider of wireless communications services. In one embodiment the MNO supports CAMEL (Customized Applications for Mobile networks Enhanced Logic) and USSD (Unstructured Supplementary Service Data) signaling protocols. The MNO owns or controls all the elements necessary to sell and deliver mobile communication services to an end user including a radio spectrum allocation/license from a regulatory or government entity, wireless network infrastructure, backhaul infrastructure, billing, provisioning computer systems, customer care, marketing and repair organizations.

MNO 102 is connected to enterprise hardware 104 via two connections, signaling channel 202 and call channel 203.

Signaling channel 202 is an internet 106 signaling channel. More specifically, in one embodiment, signaling channel 202 connects a MNO proxy server to an ECS input/output adaptor. In a preferred embodiment communication between the MNO server and ECS via signaling channel 202 is through Internet Protocol (IP) using Hypertext Transfer Protocol (HTTP) and Hypertext Transfer Protocol Secure (HTTPS) commands. In a preferred embodiment signaling channel 202 supports a mutual certification exchange. In a preferred embodiment an enterprise firewall (not illustrated in FIG. 1) between MNO 102 and ECS 108 is configured to forward only HTTP and HTTPS ports to the ECS and only from specific predefined IP addresses of MNO proxy server or servers; all other inbound communications from the internet are blocked. In a preferred embodiment the communication between the MNO and ECS is based on a pre-defined Application Interface (API) between the MNO proxy server(s) and the ECS input/output adapter.

In an additional embodiment an enterprise a Web Application Firewall (WAF), as is known in the art (not illustrated in FIG. 1) between MNO 102 and ECS 108 provides additional security.

Alternatively, the signaling channel can use other communication protocols such as Transport Layer Security (TLS), Secure Sockets Layer (SSL), as are known in the art.

Alternatively, the signaling channel connection between MNO and ECS can be a VPN (Virtual Private Network).

Other standard security techniques can be used, for example: Communication between the MNO proxy server and the ECS input/output adaptor can be encrypted. There can be an application identification using a username and password between the MNO and the ECS.

MNO 102 communicates media data to the ECS via signaling channel 202. Media data, in the case of calls includes call requests and call metadata. Media data in the case of text messages includes text message requests, the text message itself as well as text message metadata. Media data in the case of EMD data communications includes EMD data communication requests and the EMD data communication itself as well as EMD data communication metadata. ECS 108 communicates commands, requests and data as will be described in more detail below e.g. DID numbers, instructions as to where to send EMD communications, to MNO 102 through signaling channel 202.

MNO 102 routes calls to enterprise hardware 104 via call channel 203. Specifically, in one embodiment, channel 203 connects to PBX 112. In one embodiment call channel 203 is a Direct Inward Dialing (DID) connection and the MNO can connect a call to the PBX by Direct Inward Dialing (DID) by, for example, using T1/E1 connectivity as is known in the art.

The combination of signaling channel 202 and call channel 203 mean that media data can be passed in a simple, secure fashion to the enterprise (via signaling channel 202) whilst calls can be directly connected to and through the enterprise (via call channel 203). This is an improvement over existing communication recording technologies as calls (and other communications as will be described below) are directly routed, recording is enterprise-based, and necessary data exchange is through a simple signaling channel.

The MNO receives a communication initiation from the EMD when the EMD attempts to make a call, send a text message or access data services. These communication initiations are signaling based communications initiations, via signaling protocols e.g. CAMEL, USSD. It is important to note that this is in contrast to and unlike application based mobile communication recording systems of the art, as mentioned previously, where communication initiations received by the MNO are via data (e.g. using 3G). Furthermore, in embodiments when the communication is a voice call or a text message, data services of the MNO are not used and, as is described in more detail regarding exemplary embodiments below, the system and method operate using signaling alone. An exception to this, is an embodiment of the invention where the EMD communication is a data communication, where although the EMD communication initiation is via signaling, data services of the MNO are eventually employed in EMD data communications. In summary, except in the case of EMD data communications, the EMD and the MNO communicate via signaling.

In one embodiment the MNO uses a database to recognize or identity communication initiations from or to EMD devices. In one embodiment the MNO recognizes EMD communication initiations using a MNO database. The database of EMD devices can be by, for example, IMSI numbers, MSISDN numbers, ICCID numbers, and in the case of data communications it can be by Access Point Name (APN). The MNO database stores a pre-allocated enterprise IP address for each EMD or group of EMDs. A number of EMDs can have the same enterprise IP address. This IP address is the address that the MNO server uses to communicate with the ECS input/output adaptor.

The MNO is able to recognize EMD communication initiations so that upon receiving a communication initiation, e.g. call initiation, a SMS initiation or a data communication initiation, to or from an EMD the MNO does not route the communication as usual but sends a request, through signaling channel 202 to ECS 108.

Enterprise Compliant Server (ECS) 108 uses ECS invention software to control EMD communication flow and recording. ECS is able to associate information received via signaling channel 202 with calls on the PBX 116 (calls either received via DID or dialed using, for example, MSRN/MSISDN numbers). In one embodiment, when the communication is a voice call, the ECS associates a DID call with a MSISDN number.

ECS 108 controls media flow into the enterprise by communicating with MNO 102 through the signaling channel 202 e.g. responding to call requests, providing DID numbers for calls and by routing or connecting calls through the PBX (or PSTN directly in embodiments lacking a PBX). ECS 108 controls recording by conferencing media (e.g. calls received via DID to the PBX or calls connected by ECS using MSRN or MSISDN numbers) to the ERS along with metadata received through the signaling channel. Control of the system by the ECS will be described in detail in the description of various exemplary embodiments below.

Enterprise Private Branch Exchange (PBX) 112 also termed “enterprise soft switch” is a standard PBX which switches calls into and out of the enterprise. The PBX can be an Internet Protocol (IP) PBX. The PBX can be in a standalone configuration or optionally can be concatenated to an additional enterprise by an additional PBX of either Time Division Multiplexing (TDM) or IP type optionally through a gateway (not illustrated in FIG. 1).

ECS 108 is connected to PBX 112 via connection 204. In one embodiment connection 204 is a SIP trunk. Alternatively, communication between ECS 108 and PBX 112 via connection 204 can be by other standard interfaces such as E1/T1, FXO/FXS and BRI. In one embodiment a range of DID numbers on the PBX are software-assigned to the ECS; internal virtual resources of the ECS are allocated to each DID. If a call is placed to one of these DID numbers on the PBX this software-assignment causes the call to automatically “ring on” or connect to the ECS.

The ECS can connect a call through the PBX and PSTN (using connections 204 and 208) to an EMD by calling a MSRN (Mobile Subscriber Roaming Number) or, alternatively, by calling a MSISDN (Mobile Station International Subscriber Directory Number). The MSRN is a temporary mobile number that a MNO associated with the mobile device allocates to a call in the MNO network. The MSISDN is a number uniquely identifying a subscription in a mobile network. Connection of a call from PSTN 116 to EC 118 is via connection 210. Connection of a call from PSTN 116 to EMD 100 is via connection 203 to MNO 102 and then from MNO 102 to EMD 100 via connection 200.

The ability of the system of the invention to connect a call to a mobile device using a MSISDN number is an advantage as MNOs are not always willing to provide MSRN numbers to external entities or partners. In another embodiment where the system lacks a PBX the ECS can connect a call directly through the PSTN.

Enterprise PBX 112 can be directly connected to PSTN 116, illustrated by connection 208 in FIG. 1, or can be connected to the PSTN via a gateway (not illustrated). The PSTN gateway translates SIP into various PSTN protocols, as is well known in the art.

In one embodiment the system lacks a PBX. In this embodiment ECS 108 routes and receives calls through the PSTN.

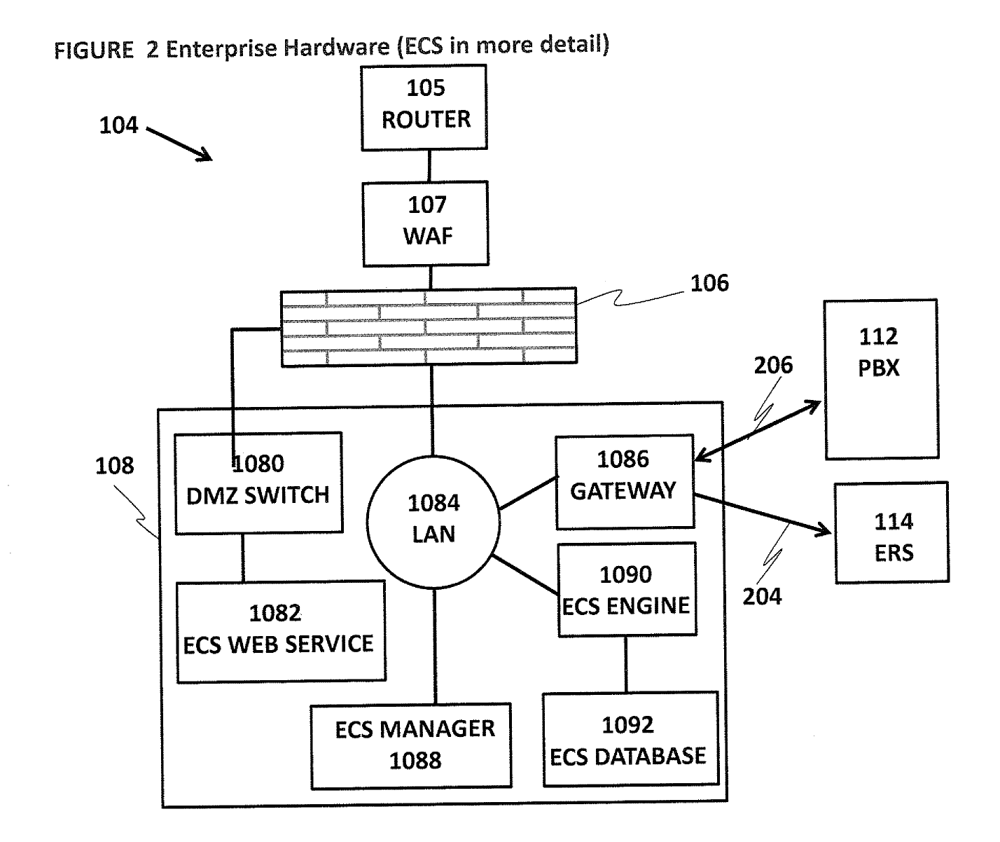

A more detailed illustration of an embodiment of the enterprise hardware 104 is illustrated in FIG. 2. In this embodiment enterprise hardware 104 further includes an internee router 105, a firewall 106 and a Web Application Firewall (WAF) 107. ECS 108 includes a Demilitarized Zone (DMZ) switch 1080, an ECS web service 1082, a Local Area Network (LAN) 1084, a gateway 1086, an ECS manager 1088, an ECS engine 1090 and an ECS database 1092.

ECS web service 1082 includes an ECS input/output adaptor and is connected to the system signaling channel (not illustrated in FIG. 2) via router 105, firewall 106, a WAF 107, and DMZ switch 1080. The ECS web service can be implemented using an IIS (Internet Information Services) server, as is known in the art. ECS web service 1082 controls the ECS interaction with the MNO via the signaling channel, firewall 106, WAF 107 and DMZ switch 1080 providing security. Firewall 106 and WAF 107 also act to separate ECS web service 1082 from other parts of the system.

In this embodiment ECS engine 1090 implements ECS policy manager functionality including accessing ECS database 1092. ECS database 1092 can be onsite in the enterprise as illustrated in FIG. 2 or in a central offsite database. ECS engine 1090 also provides call routing and conferencing functionality of the ECS which is described in more detail below. ECS engine 1090 communicates with PBX 112 and ERS 114 via LAN 1084 and gateway 1086: Gateway 1086 converts SIP commands from ECS engine 1090 into PRI/BRI or E1/T1 etc. LAN 1084 is also connected to ECS manager 1088. ECS manager 1088 (which can be implemented using an ITS server, as is known in the art) includes an interface which provides access to and management of the system to the enterprise.

In an alternative embodiment the ECS can lack a gateway and a LAN, the ECS engine directly communicating with the ERS and PBX using SIP.

In a further embodiment the ECS can include more than one engine, additional engines implementing channel handling and concurrency resiliency including load balancing between servers, using strategies known in the art, providing robustness to the system.

The ECS functionality can also include Interactive Voice Response (IVR) and conferencing functionality similar to that of a media server: The ECS offers conferencing functionality, “play” and “record” functionality, speech recognition, and text-to-speech translation. The “play” function involves playing a previously recorded message to a user. The “record” function involves recording messages and calls. Speech recognition involves comparing a user's utterance to a recorded signal. Text-to-speech translation involves converting written words to speech and playing them to a user or a conference of users. The ECS functionality can further include other features such as hold, cancel, call transfer etc.

The ECS functionality can include a policy manager. The policy manager uses policy data stored on an ECS database to authenticate requests from the MNO to the ECS. This includes for example user Mobile Station International Subscriber Directory Number (MSISDN) or IMSI authentication, service authorization for the user, querying the destination number dialed by the cellular user in order to implement personal white-listing so that private communications will not be recorded by the ERS, etc.

The various components of the ECS can be integrated in many ways, as is well known in the art. Two or more of the ECS functions (for example media server functionality) can be integrated into a single device, or can be even integrated into the PBX.

Returning now to FIG. 1, Enterprise Recording System (ERS) 114 records and stores media as defined as voice, text message and data communications. Communication between ECS 108 and ERS 114 is through connection 204 and is preferably through SIP but can alternatively be through a gateway using standard interfaces such as by E1/T1, FXO/FXS and BRI. ECS 108 conferences the media to be recorded to ERS 114 can provide additional metadata information to be stored with the media for data storage and retrieval purposes. Examples of metadata include: enterprise user ID number, direction of the call (inbound or outbound), call time and date, etc.

Metadata associated with recording of media for data storage and retrieval by the ERS is passed with the media to be recorded from the ECS to the ERS. If communication between the ECS and ERS is by SIP then metadata information can be provided as part of a SIP invite e.g. in the SIP invite header, from the ECS to the ERS. If communication between the ECS and ERS is through a gateway using standard interfaces such as E1/T1, FXO/FXS, and BRI the ECS can provide the ERS with metadata information by changing and manipulating fields of the protocol invites. The aforementioned options for communication of metadata are exemplary and non-restrictive. In another embodiment there is an additional connection which can be an Internet Protocol (IP) connection between the ECS and the ERS for transferring text information e.g. metadata, text message communications etc.

The Enterprise Mobile Device (EMD) 100 has a cell interface connected to an antenna and is operable in a cellular network. The EMD is also termed interchangeably in this document “enterprise cellular device”, “mobile device”, “cellular device”, “enterprise mobile phone”, “enterprise cellular phone”, “mobile phone”, “cellular phone”, “cell phone” etc. The terms “user”, “enterprise employee”, “enterprise mobile user” and “mobile user” are used interchangeably to refer to the individual using the EMD. The EMD includes a Subscriber Identity Module (SIM) card provided by the MNO.

In one embodiment of the invention the EMD SIM card is a standard SIM card as is known in the art with only one International Mobile Subscriber Identity (IMSI) number. Alternatively, the SIM card can include nonstandard features: The SIM card can have multiple IMSI numbers. The SIM card can include an intelligent SIM Toolkit (STK) application for determining an operation mode (e.g. CAMEL mode, USSD mode, CAMEL/USSD converged mode) and selecting an IMSI (if the SIM card has more than one IMSI). The STK application is implemented by the EMD sending and receiving information to the SIM card through the SIM card input/output adaptor, as described below.

In one embodiment the SIM STK application sends a STK originated USSD message upon switch-on of an EMD device including the SIM or upon a change in network coverage e.g. moving out of home MNO network range, moving from the range of one visited MNO to the range of another visited MNO.

In one embodiment, if the EMD device including the SIM is out of the range of the home MNO, then the visited MNO passes the STK originated USSD message to the home MNO. The home MNO then responds with a command that is received by the SIM STK as to which IMSI to use and/or which mode to use. Alternatively, the visited MNO responds with a Mobile Country Code (MCC) and/or a Mobile Network Code (MNC), providing an EMD location to the STK and the STK then automatically chooses an IMSI and/or a mode of operation based on the EMD location.

In one embodiment, the home MNO selects a mode and/or an IMSI number selection based on the visited network using a MNO database. In one embodiment the MNO database includes suitable operation modes and/or IMSI numbers for a number of world MNOs which can operate as visited MNOs in the system of the invention.

In one embodiment, the STK application automatically selects a mode and/or an IMSI number selection based on the visited network by using a SIM database which includes suitable operation modes and/or IMSI numbers for a number of world MNOs which can operate as visited MNOs in the system of the invention.

In one embodiment STK implements automatic IMSI selection using a SIM database which specifies which IMSI to select based on a MCC or a MNC which the MNO (either the home MNO or the visited when in roaming mode) communicates to the EMD.

In one embodiment STK determines an automatic operation mode selection using a SIM database which specifies which operation mode to select based on a Mobile Country Code (MCC) or a Mobile Network Code (MNC) which the MNO communicates to the EMD.

Once the STK has selected an operation mode and/or an IMSI number it is able to implement the use of the operation mode and IMSI number by the EMD.

The Enterprise Customer (EC) also interchangeably termed “customer”, is the device (or individual) receiving a communication/media initiated by the EMD and the device (or individual) initiating a communication/media received by the EMD. The EC can be another cellular phone, a fixed line phone, a fax, a computer, a tablet, or any other device capable of receiving a voice or SMS or data communication e.g. email.

The types of communication recordable by the system and method of the invention are voice, SMS and data communications including outbound and inbound communications to the EMD. Communications are recordable both when the EMD is physically located in the home-country and when the EMD is located outside the home-country or outside the range of the MNO and is operated in roaming mode.

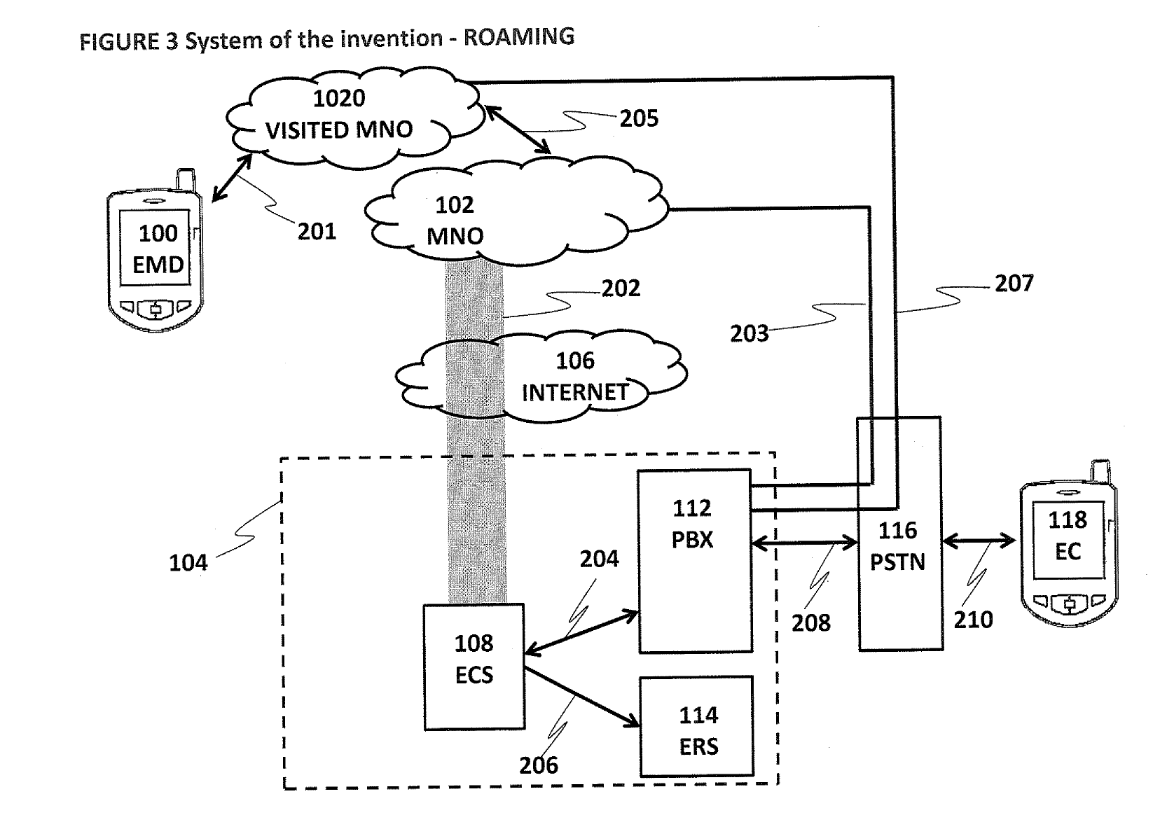

As discussed above, in various embodiments, in roaming mode the STK is able to choose an operation mode (e.g. CAMEL, USSD) and/or an IMSI using USSD-based communications with the roaming and/or home MNO. The system of the invention can operate in a roaming mode as illustrated by FIG. 3. In roaming mode a visited MNO 1020 provides cellular coverage to EMD 100 through a connection 201. When in roaming mode MNO 102 is termed “home” MNO. In the roaming mode visited MNO 1020 communicates with home MNO 102 via a connection 205. Connection 205 can include more than one connection type, it can include an international call carrier, home MNO 102 can also communicate with visited MNO 1020 using Signaling System 7 (SS7) protocol. In FIG. 3 a local or visited MNO 1020 directly provides cellular connectivity to the EMD via a connection 201 and call routing via a roaming call channel 207. However, signaling channel 202 remains between “home” MNO 102 and ECS 108. Communication of necessary commands and information between MNO 102 and visited MNO 1020 is by a connection 205. As will be described in more detail with respect to exemplary embodiments calls routed from the enterprise (from PBX 112) to EMD 100 can be routed in two ways. PBX 112 can route the call to MNO 102 by the enterprise dialing a MSISDN number associated with the EMD. MNO 102 then connects the call to EMD 100 through connection 205 to visited MNO 1020 which connects the call to EMD 100 through connection 201. Alternatively, PBX 112 can route the call directly through connection 207 to visited MNO 1020 which connects the call to EMD 100 by dialing a MSRN number associated with the EMD.

The system of the invention can operate in more than operation mode including a direct dialing mode and call-back mode. Specifically, the system of the invention can operate in a direct dialing CAMEL mode or in a call-back USSD mode or a call-back CAMEL/USSD converged mode (also termed “CAMEL call-back” mode). In the direct dialing mode the EMD user dials using direct dialing and the MNO connects the call from the EMD to the enterprise. In the USSD call-back mode the EMD dials using USSD and the call is eventually connected to the EMD by the enterprise dialing the EMD. In CAMEL call-back mode the user dials using direct dialing but (as will be described in more detail below) the call is rejected and the call is eventually connected to the EMD by the enterprise dialing the EMD.

The system of the invention can also use alternative communications protocols as known in the art. The mode of operation can be determined either on demand or permanently by default. The mode can determined in advance by the EMD SIM, or by the MNO. The mode can be determined by using a STK application to choose the mode on user-demand. Alternatively, the STK can choose the mode of operation automatically based on a location (e.g. by using MNC and/or MCC numbers) of the EMD. The home MNO can determine and set the mode of operation by communicating with the STK via USSD which enable the mode Over The Air (OTA). In a roaming mode the visited MNO can determine and set the mode of operation by sending USSD commands to the STK which enable the mode Over The Air (OTA). In addition and respectively, a setup is required in the mobile network to support these options.

Non-restrictive, exemplary embodiments of the invention are now disclosed in detail.

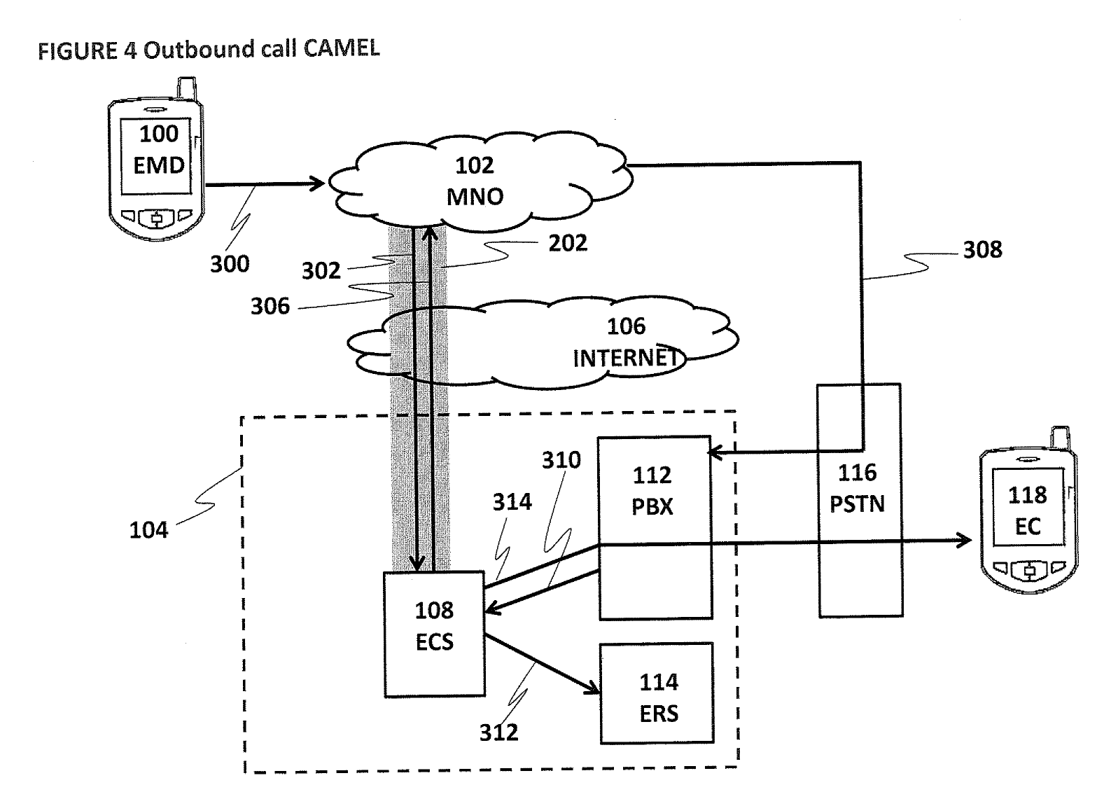

The following describes in more detail an exemplary scenario of an outbound call from the EMD when the EMD is operated in a direct dialing or a CAMEL mode. The description is with reference to FIG. 4. Operation in CAMEL, mode requires connection to a mobile network that supports CAMEL and use of a CAMEL mode by the EMD.

User/EMD 100 dials destination number/EC 118 using direct dialing or CAMEL. This causes a notification to be initiated to the MNO (step 300) as it is sent via CAMEL this communication initiation is a signaling based EMD communication initiation. The MNO recognizes/authenticates that the call is from an EMD and then sends through a MNO proxy server a HTTP or HTTPS “Authenticate Outbound Call” communication request to the ECS (step 302). More specifically, this “Authenticate Outbound Call” request is delivered via signaling channel 202 using a predefined API to an ECS input/output adapter at a unique and fixed IP address in the enterprise premises which has been pre-allocated to the particular EMD or the group of SIMs that the EMD belongs to. The “Authenticate Outbound Call” request from the MNO to the ECS includes metadata associated with the call, e.g. the call destination number, the EMD MSISDN/IMSI/ICCID etc. The ECS policy manager uses stored policy data to internally authenticate the request, including for example MSISDN/IMSI/ICCID authentication, service authorization for the user, querying if the destination number appears on the user white-list. Once the request is internally authenticated the ECS allocates an ECS free and unoccupied internal channel associated with a Direct Inward Dialing (DID) number on the enterprise PBX for the call. The ECS then, through the ECS input/output adaptor, sends an authentication including the DID number (step 306) to the MNO instructing the MNO proxy server to redirect the outbound call to the DID number on the enterprise PBX which has been allocated to this call. The MNO then directs the call to the DID number on the PBX (step 308). Because the ECS has allocated the DID number to the call, the ECS can synchronize media data received through the signaling channel from the MNO with the call voice signal received via the PBX (step 310). The ECS then queries the ECS policy manager to check if the number dialed is on the user's personal white-list. If the number is not on the white-list the policy manager indicates that the call should be recorded and the ECS conferences the call to the ERS for recording providing necessary metadata information as described above (step 312). Optionally, an ECS Interactive Voice Response (IVR) functionality can inform the caller whether the call is being recorded or not by prompting a suitable prerecorded message. The ECS conferences the call to the destination initially dialed through the PBX and PSTN whilst manipulating the caller ID to the user's mobile phone number (EMD phone number) or alternatively other desired number such as the user's desk-phone number (step 314). If the EC is a mobile device the PSTN will connect to an MNO (not illustrated) before reaching EC 118.

The invention supports various call scenarios involving call-back. The term “Call-back” is used to refer to modes where the EMD initiates a call to the EC but the call is eventually connected by the ECS dialing/conferencing both the EMD and the EC. This can be advantageous in terms of cost and cellular coverage, especially if the EMD is outside the MNO network, in a roaming mode. The ability of the embodiments of the system of the invention to operate in a USSD mode is advantageous in terms of coverage as USSD is supported by most world MNOs, unlike CAMEL.

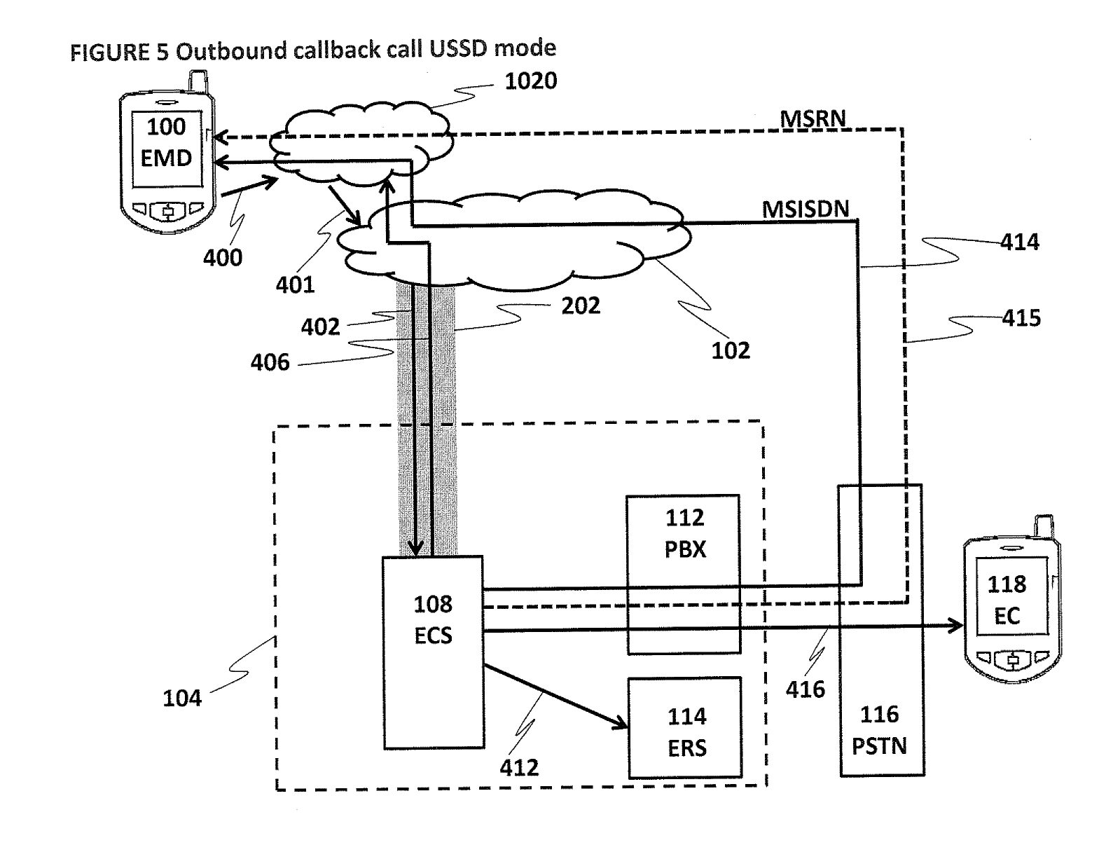

The following describes in more detail an exemplary scenario of an outbound call from the cellular device when the mobile device is in a USSD roaming callback mode. USSD callback mode can preferentially be selected while roaming for cost-saving purposes as direct dialing using visited MNO 1020 can be very expensive. The description is with reference to FIG. 5. Although the figure illustrates a roaming mode where a visited MNO 1020 provides cellular coverage to EMD 100 USSD callback mode in a non-roaming mode is encompassed by the invention and might be desirable if the EMD is in a location where MNO 102 lacks CAMEL network coverage. Operation in USSD callback mode requires connection to a mobile network that supports USSD and use of a USSD mode by the EMD.

The user can dial in a USSD format by adding a leading asterisk symbol (*) to the dial string (EC phone number) and adding a hash symbol (#) as a suffix to the end of the dial string when dialing. Alternatively, if the EMD SIM provided uses a STK application, once the user direct-dials in the usual fashion to the destination required e.g. by using the cellular phonebook, the SIM memory, or by simply keying in the number, the STK application, can be set to automatically disconnect the original call request and initiate a USSD message including the destination number originally dialed by the user (EC number) to the visited MNO (step 400).

Once visited MNO 1020 receives the USSD message, a call initiation which, as it is via USSD, is a signaling based call/communication initiation. Visited MNO 1020 transfers the call initiation to MNO 102 (step 401). MNO 102 recognizes/authenticates that the initiation is from an EMD and then sends through a MNO proxy server a HTTP or HTTPS “Authenticate Callback” request to the ECS (step 402). More specifically, this “Authenticate Callback” request is delivered via signaling channel 202 using a predefined API to an ECS input/output adapter at a unique and fixed IP address in the enterprise premises which has been pre-allocated to the particular EMD or the group of SIMs that the EMD belongs to. The “Authenticate Callback” request from the MNO to the ECS includes metadata associated with the call, e.g. the call destination number, MSISDN/IMSI/ICCID etc. The ECS policy manager uses stored policy data to internally authenticate the request, including for example MSISDN/IMSI/ICCID authentication, service authorization for the user, querying if the destination number appears on the user white-list, etc.

Once the request is internally authenticated the ECS allocates a free and unoccupied internal ECS channel associated with a Direct Inward Dialing (DID) number on the enterprise PBX for the call. The ECS then queries the ECS policy manager to check if the number dialed is on the user's personal white-list. If the number is not on the white-list the policy manager indicates that the call should be recorded and ECS 108 conferences the media to ERS 114 for recording purposes providing necessary metadata information to the ERS (step 412). The ECS then, internally authenticates the call. Upon internal authentication the ECS, through the ECS input/output adapter, sends a “Get MSRN” request through the API to the visited MNO 1020 proxy server to retrieve the MSRN (Mobile Subscriber Roaming Number) of the cellular user in the cellular network (step 406). Step 406 is optional as the ECS can route the call using the MSRN number acquired in step 406 or the MSISDN number which can be passed to the ECS in step 402. Then, the ECS completes authorization of the communication (call) request by either calls back the user's MSRN (temporary mobile number allocated for the call in the registered network) in a conference mode through the enterprise PBX (step 415 illustrated as a dashed line) or the ECS calls back the user's MSISDN number in a conference mode through the enterprise PBX (step 414). The EMD user then answers the callback. At this point, the ECS interactive voice response (IVR) functionality can inform the cellular user whether the call is being recorded or not by prompting a suitable prerecorded message and then, the ECS conferences the call to the destination initially dialed, EC 118, by the cellular user through the enterprise PBX (step 416). During step 416 ECS 108 can conference the call while manipulating the Caller ID to the user's original number, or another desired number e.g. user desk phone number, for call identification purposes.

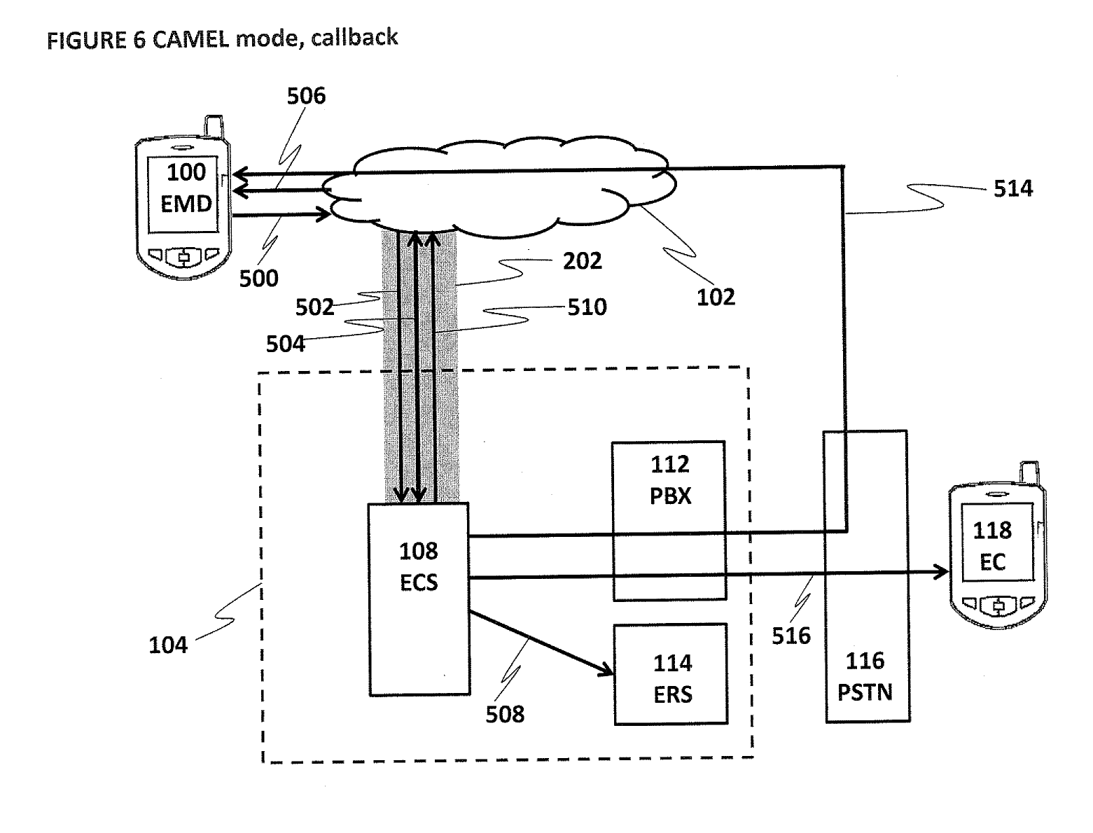

For cost savings purposes and/or when the EMD is in a location without USSD coverage, it is possible also to work in CAMEL mode and implement a callback flow scenario for recording an outbound call initiated by the mobile user of EMD 100. The following describes in more detail a CAMEL based callback flow scenario in a roaming mode. The description is with reference to FIG. 6 which illustrates an outgoing voice call via CAMEL protocol in callback mode. As mentioned above, operation in CAMEL mode requires connection to a mobile network that supports CAMEL and use of a CAMEL mode by the EMD. A CAMEL or direct dialing callback mode in a roaming mode is also envisioned and encompassed by the invention.

The user dials destination number using direct dialing or CAMEL. This causes a notification to be initiated to MNO 102 (step 500). This EMD communication initiation is a signaling based communication initiation as it is via CAMEL. MNO 102 recognizes/authenticates that the call initiation is from an EMD and then sends through a MNO proxy server a HTTP or HTTPS “Authenticate Outbound Call” request to the ECS (step 502). More specifically, this “Authenticate Outbound Call” request is delivered via the MNO-ECS signaling channel 202 using a predefined API to an ECS input/output adapter at a unique and fixed IP address in the enterprise premises which has been pre-allocated to the particular EMD or the group of SIMs that the EMD belongs to. The ECS policy manager internally authenticates the request and instructs the MNO proxy server (through the ECS input/output adapter) to reject the call (step 504). The MNO then rejects the call (step 506). Then the ECS can optionally send a USSD message to the EMD through an API predefined with the MNO which can pop up on EMD screen informing the user to “wait for a callback” (not illustrated). Alternatively, the MNO upon receiving instructions to reject the call can directly send a USSD message to the EMD which can pop up on EMD screen informing the user to “wait for a callback” (not illustrated). The ECS authenticates the call request then conferences the ERS for recording of the call (step 508). ECS can then, optionally, send a “Get MSRN” request to the MNO proxy server to retrieve the MSRN of the cellular user in the cellular network (step 510). This step is optional, as the ECS can conference the call to the EMD using the EMD MSISDN number which can be provided to the ECS in step 502. The ECS then either conferences the EMD MSRN (or alternatively the EMD MSISDN) through PBX 112 and PSTN 116 (step 512). When the user answers the callback the ECS interactive voice response (IVR) functionality can inform the cellular user whether the call is being recorded or not by prompting a suitable prerecorded message and then, the ECS conferences the call to the destination required (EC number initially dialed by the cellular user) through the enterprise PBX while manipulating the Caller ID to the user's original number or another desired number such as the user's desk-phone number for call identification purposes (step 516). The callback functionality offered by the system of the invention is highly advantageous for situations where the user is in roaming mode as it allows the enterprise/user to avoid the high cost of direct dialing while roaming.

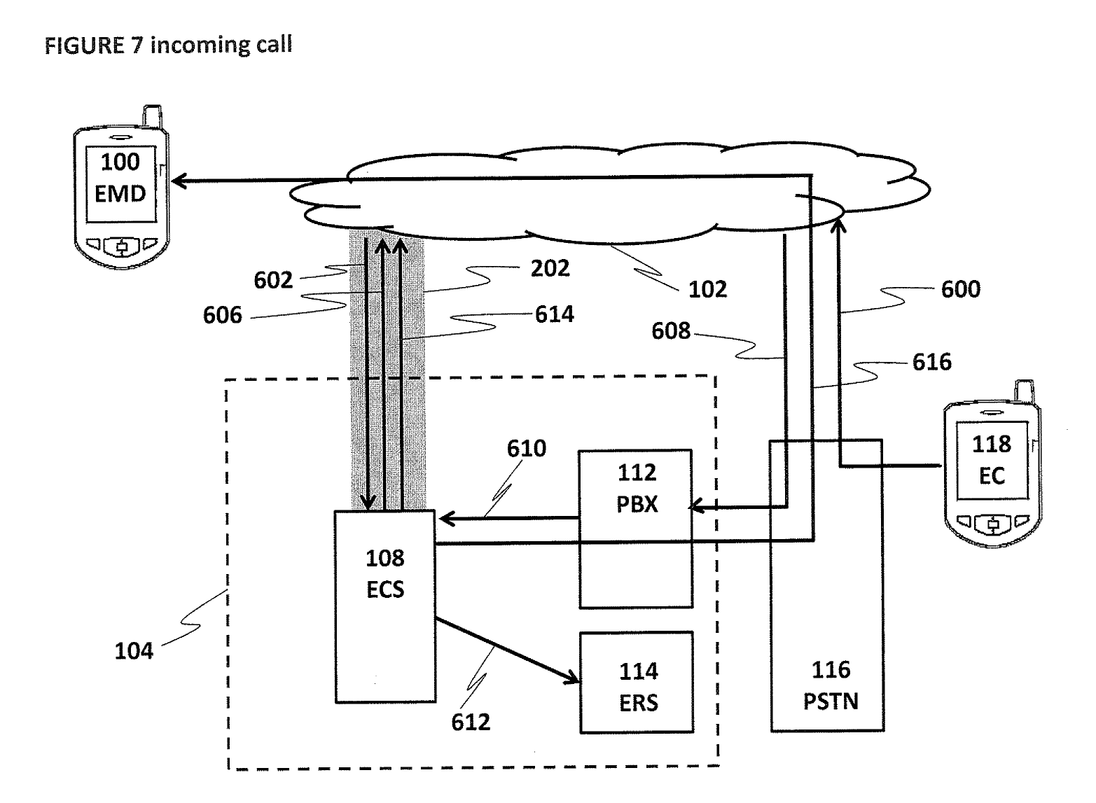

The following describes in more detail an exemplary scenario of an incoming call to the EMD. The description is with reference to FIG. 7. When EC 118 dials EMD 100, the MNO receives an incoming call request, a call initiation, concerning EMD 100 (step 600). The MNO recognizes/authenticates that the call is to an EMD and then sends through a MNO proxy server a HTTP or HTTPS “Authenticate Inbound Call” request to the ECS (step 602). More specifically, this “Authenticate Inbound Call” request is delivered via signaling channel 202 using a predefined API to an ECS input/output adapter at a unique and fixed IP address in the enterprise premises which has been pre-allocated to the particular EMD or the group of SIMs that the EMD belongs to. The ECS policy manager uses stored policy data to internally authenticate the request, including for example EMD MSISDN/IMSI/ICCID authentication, service authorization for the user, querying if the caller (EC) number appears on the user white-list. Once the request is internally authenticated the ECS allocates a free and unoccupied internal channel associated with a Direct Inward Dialing (DID) number on the enterprise PBX for the call and then, through the ECS input/output adaptor instructs the MNO proxy server to redirect the inbound call to the DID number on the PBX which has been allocated to this call (step 606). The MNO therefore redirects the call to the DID number provided (step 608). Because the ECS has allocated the DID number to the specific call, and the ECS once it has allocated the DID expects to receive in a predefined time slot (e.g. within a few seconds of the DID allocation) an inbound call on the allocated DID number, the ECS can synchronize call data received through the signaling channel from the MNO with the call voice signal received via the PBX (step 610). The ECS then queries the ECS policy manager to check if EC 118 telephone number is on the user's personal white-list. If the number is not on the white-list the policy manager indicates that the call should be recorded and the ECS conferences the media to ERS 114 for recording providing necessary metadata information as described above (step 612). Optionally, the ECS Interactive Voice Response (IVR) functionality can inform the EC caller whether the call is being recorded or not by prompting a suitable prerecorded message. Then, optionally, the ECS input/output adapter sends a “Get MSRN” request through the API to the MNO proxy server to retrieve the MSRN (Mobile Subscriber Roaming Number) of the cellular user in the cellular network (step 614). Step 614 is optional as the ECS can route the call without knowing the MSRN by using the MSISDN which can be passed to the ECS in step 602. The ECS then authenticates the communication request and receives the communication by conferencing the user's MSRN (temporary mobile number allocated for the call in the registered network), or alternatively the user's MSISDN number through the enterprise PBX, PSTN and MNO while manipulating the Caller ID to the EC caller original number for call identification purposes (step 616). The user can answer the inbound call and optionally the ECS interactive voice response (IVR) functionality can inform EMD user and/or the EC caller if the call is being recorded or not by prompting a suitable prerecorded message.

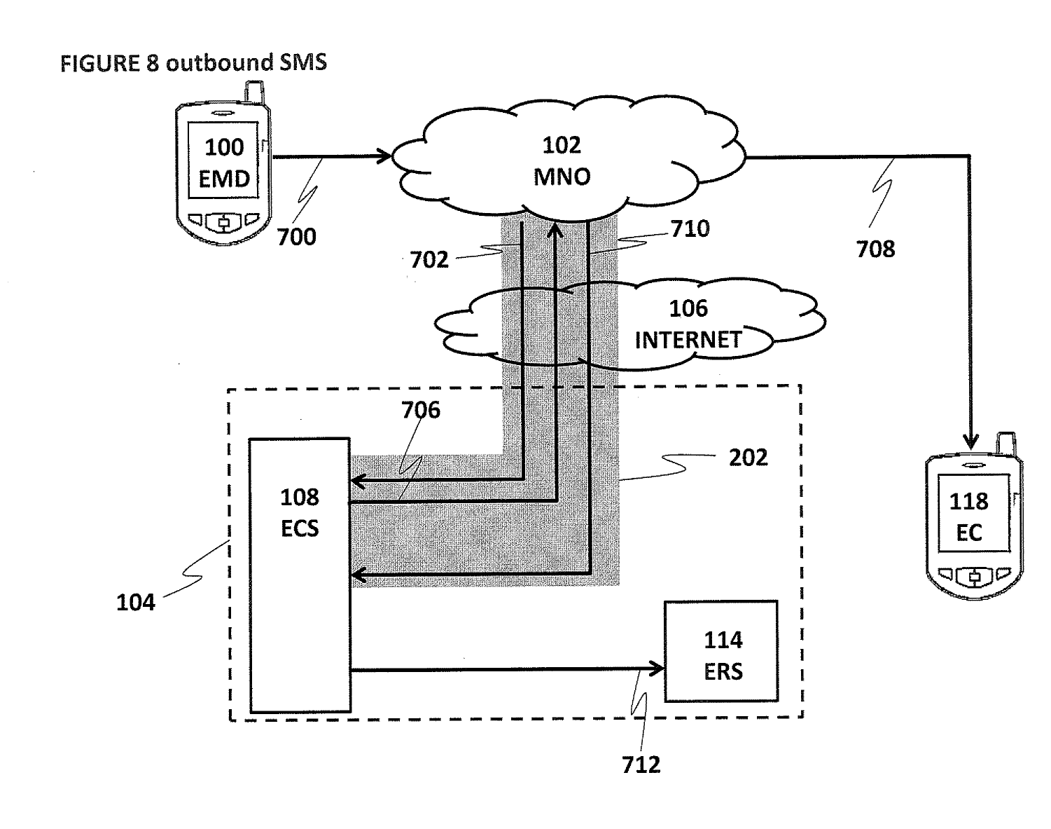

The following describes in more detail an exemplary scenario of an outbound SMS sent from the EMD cellular device. The description is with reference to FIG. 8. When EMD 100 attempts to send a SMS, an outbound SMS communication initiation is sent to MNO 102 (step 700). The outbound SMS communication initiation, an EMD communication initiation is a signaling based communication initiation. The MNO server recognizes that the communication initiation is from an EMD and then sends a HTTP or HTTPS communication request through signaling channel 202 to the ECS input/output adapter at a unique and fixed IP address in enterprise premises 104 which has been pre-allocated to the particular EMD (step 702). The request is an “Authenticate Outbound SMS” request via a predefined API to the ECS input/output adapter. The ECS policy manager uses policy data to internally authenticate the request, including for example user MSISDN/IMSI/ICCID authentication, service authorization for the user and querying if the destination number appears on the user white-list. Once the request is internally authenticated the ECS authenticates the communication request by sending instructions to the MNO to send a copy of the SMS (step 706). The MNO delivers the SMS to the destination required (step 708) and the MNO server sends a copy of the outbound SMS to the ECS input/output adapter at a predefined IP address over HTTP/S (step 710). The ECS then queries the ECS policy manager to check if the number to which the outbound SMS was sent is on the user's predefined personal white-list. If the number is not on the white-list the policy manager indicates that the SMS should be recorded and the ECS delivers the SMS content and metadata (on the fly) through HTTP to the ERS in the required format (based on a predefined API between the ECS and the enterprise recording system) including the metadata information e.g. the cellular user account ID, SMS direction in/out, SMS destination, time, date, etc. necessary for data storage and retrieval purposes (step 712).

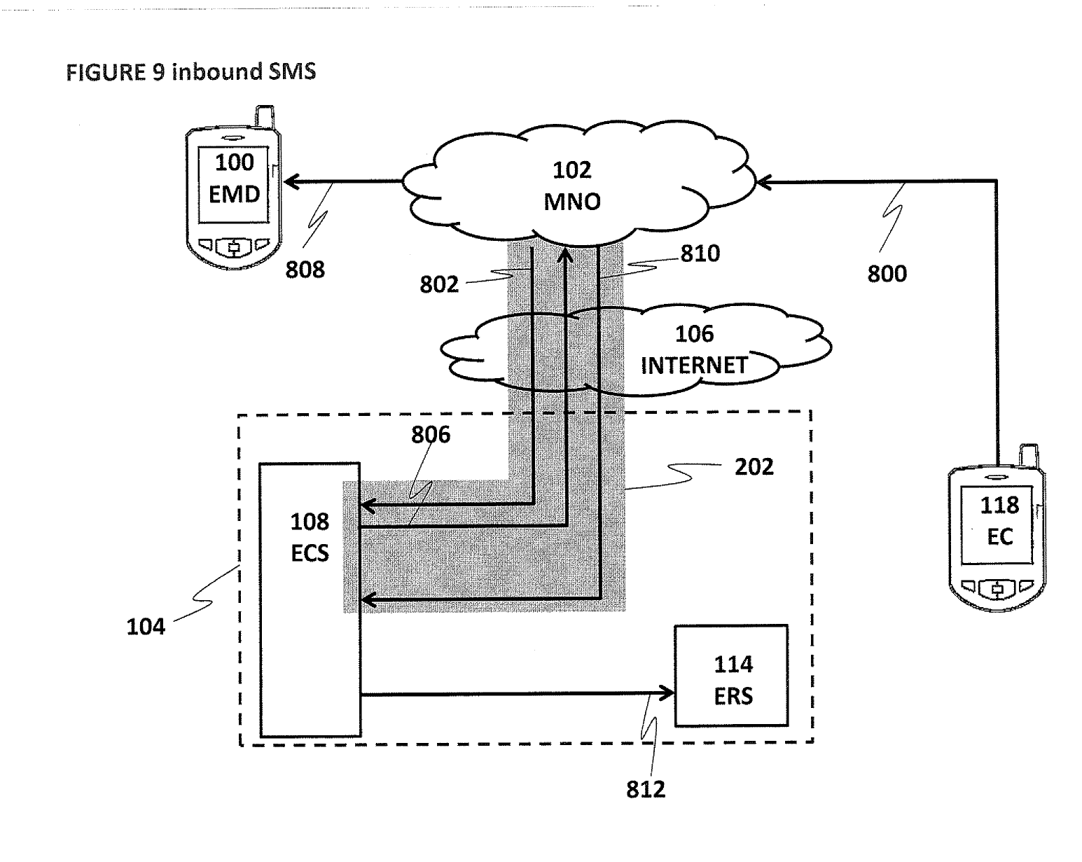

The following describes in more detail an exemplary scenario of an inbound SMS sent to the EMD cellular device. The description is with reference to FIG. 9. When EC 118 attempts to send an SMS to user EMD cellular device 100, the MNO receives an inbound communication initiation, a SMS initiation (step 800). The MNO server sends through signaling channel 202 an Internet Protocol (IP) HTTP or HTTPS communication request to the ECS input/output adapter through the signaling channel, to a unique and fixed IP address in the enterprise premises which has been pre-allocated to the particular EMD or group of SIMs to which the EMD belongs. The request is an “Authenticate Inbound SMS” request sent to the ECS input/output adapter via an API (step 802) through the Internet. The ECS policy manager uses policy data stored on the ECS database to internally authenticate the request, including for example user MSISDN/IMSI authentication of the EMD user the SMS is to be sent to, service authorization for the user, querying the caller ID number from which the inbound SMS initiation was sent, to be able to support personal white-listing so that private inbound SMS will not be recorded by the ERS. The ECS then can confirm or reject the communication request and instruct the MNO to send a copy of the SMS (step 806). The MNO delivers the SMS to the EMD (step 808) and the MNO server sends a copy of the inbound SMS to the ECS input/output adapter through the signaling channel to the EMD associated enterprise IP address (step 810). The ECS then queries the ECS policy manager to check that the caller ID number from which the inbound SMS was sent is on the user's predefined personal white-list. If the number is not on the white-list the policy manager indicates that the SMS should be recorded and the ECS delivers the SMS (on the fly) to the ERS in the required format (based on a predefined API between the ECS and the enterprise recording system) including the metadata information such as the cellular user account ID, SMS direction (in/out), sending party #, date etc. necessary for data storage and retrieval purposes (step 812).

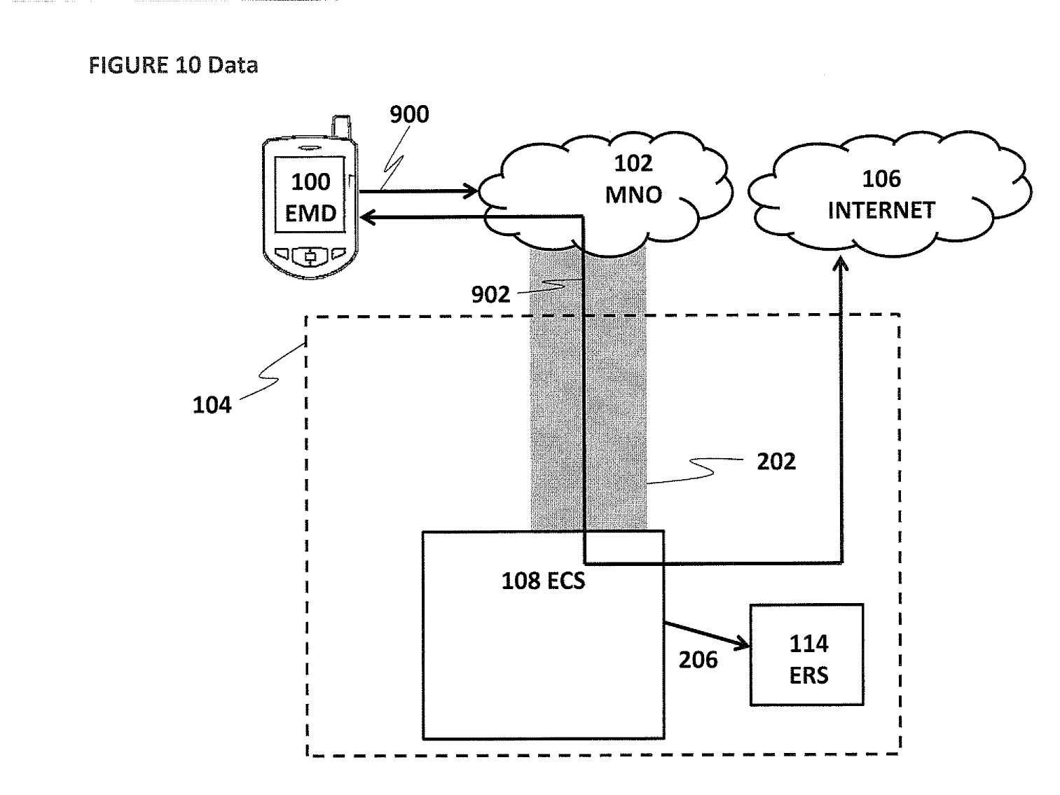

The following describes in more detail an exemplary scenario of mobile data recording by the ERS. The description is with reference to FIG. 10. In one embodiment each enterprise that requires in-house data recording capabilities has a private Access Point Name (APN) pre-defined by MNO 102. A setup is required in the mobile network to support these private APN options. When EMD 100 initiates data services over the cellular network the EMD sends a communication initiation which, in this case is a data authentication request to MNO 102 (step 900). The data authentication request which includes a private APN associated with the particular EMD enterprise. The MNO recognizes the private APN and then diverts all data traffic through enterprise hardware 104 (step 902). Therefore the enterprise is able to manage security and data recording policies for cellular user 100. All internet 106 access to the EMD is through the enterprise hardware and the enterprise terminates direct internet access to the enterprise mobile user.

In an alternative embodiment all EMDs associated with all enterprises that require in-house data recording capabilities have the SIM cards with the same APN, pre-defined by MNO 102. Then, when a data communication initiation occurs from an EMD the MNO recognizes the APN and that data communications should be recorded. The MNO then uses a look-up or database to send the data communications to the correct enterprise ECS.

The ECS advantageously can also provide additional added value features which might be necessary for mobile recording implementation and that can be configured by an enterprise administrator on demand. For example, a policy can be set in the ECS that disconnects an ongoing call if a fault develops in the ERS. In this case the call participants can be informed that disconnection is due to a fault, for example by using the ECS IVR capabilities.

The ECS and MNO server can both be implemented in hardware, firmware or software or any combination thereof. Illustrated embodiments are software embodiments.

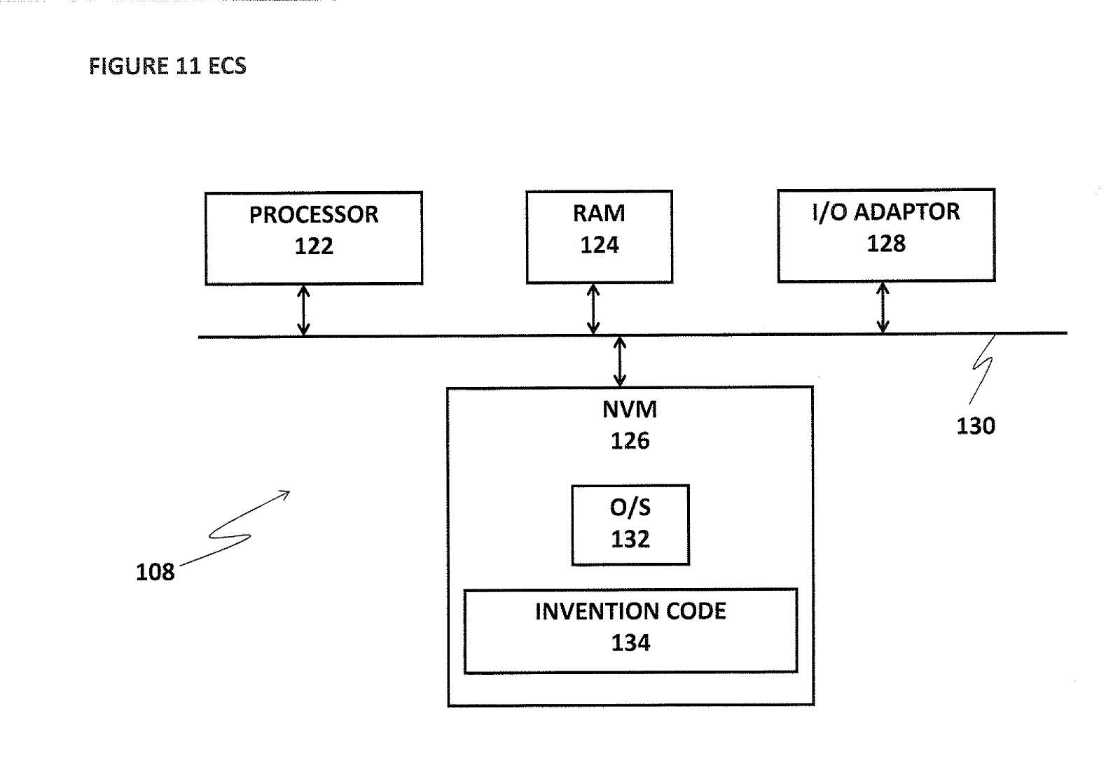

In one embodiment of the invention the invention is a software product stored in a machine-readable medium the term “machine-readable medium” herein also to be understood as referring to a computer-readable medium, a processor-readable medium, or a computer usable medium having a computer readable program code embodied therein. The machine-readable medium may be any suitable tangible medium, including magnetic, optical, or electrical storage media including diskette, compact disk read only memory (CD-ROM), memory device (volatile or non-volatile), or similar storage mechanism. The machine-readable medium may contain various sets of instructions, code sequences, configuration information, or other data, which, when executed, cause a processor to perform steps in a method according to an embodiment of the invention. Those of ordinary skill in the art will appreciate that other instructions and operations necessary to implement the described invention may also be stored on the machine-readable medium. Software code running from the machine-readable medium may interface with circuitry to perform the described tasks as described in more detail, with reference to FIGS. 11, 12 and 14, below.

FIG. 11 is a high-level partial block diagram of an exemplary ECS 108 configured to implement the present invention. Only components of ECS 108 that are germane to the present invention are shown in FIG. 11. ECS 108 includes a processor 122, a random access memory (RAM) 124, a non-volatile memory (NVM) 126 and an ECS input/output (I/O) adaptor 128, all communicating with each other via a common bus 130. In NVM 130 are stored operating system (O/S) 132 and ECS code of the present invention code 134. Invention ECS code 134 includes the ECS functionality as described above, for example ECS interactions with the MNO and PBX to control communication routing, instructions to the ERS for communication recording and ECS policy manager functionality. Under the control of OS 132, processor 122 loads invention ECS code 134 from NVM 126 into RAM 124 at boot time and executes invention ECS code 134 in RAM 124 for interactions with other elements of the system interfacing with I/O adaptor 128.

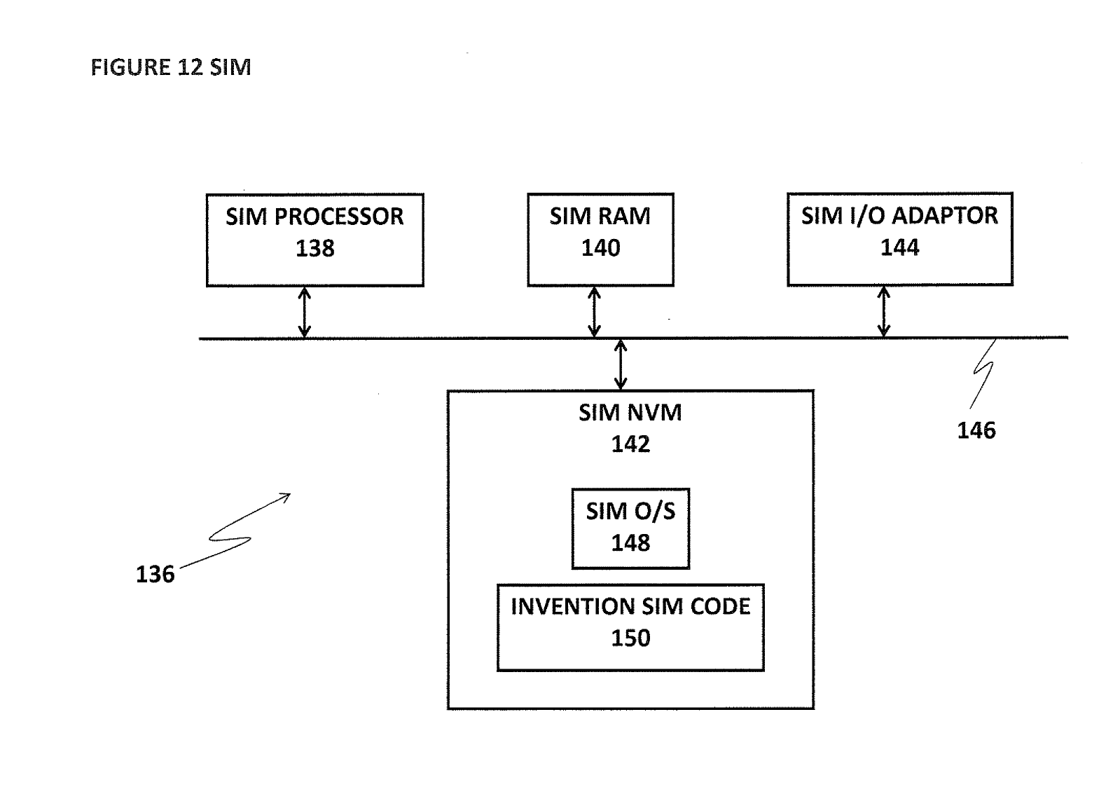

FIG. 12 is a high-level partial block diagram of an exemplary SIM card 136 configured to implement embodiments of the present invention. SIM card 136 is placed into a cellular device and interacts with the cellular device. The EMD 100 includes a SIM card of the invention and a cellular device. Only components of system 136 that are germane to the present invention are shown in FIG. 12. SIM card 136 includes a SIM processor 138, a SIM random access memory (RAM) 140, a SIM non-volatile memory (NVM) 142 and a SIM input/output (I/O) adaptor 144, all communicating with each other via a common bus 146. In SIM NVM 142 are stored SIM operating system (O/S) 148 and invention SIM code 150 of the present invention. Invention SIM code 150 includes the SIM functionality as described above for example the and providing the STK functionality including IMSI and operation mode selection. Under the control of SIM OS 148, SIM processor 138 loads invention SIM code 150 from SIM NVM 142 into SIM RAM 140 at boot time and executes invention SIM code 150 in SIM RAM 140 for interactions with the EMD which interfaces with SIM I/O adaptor 144.

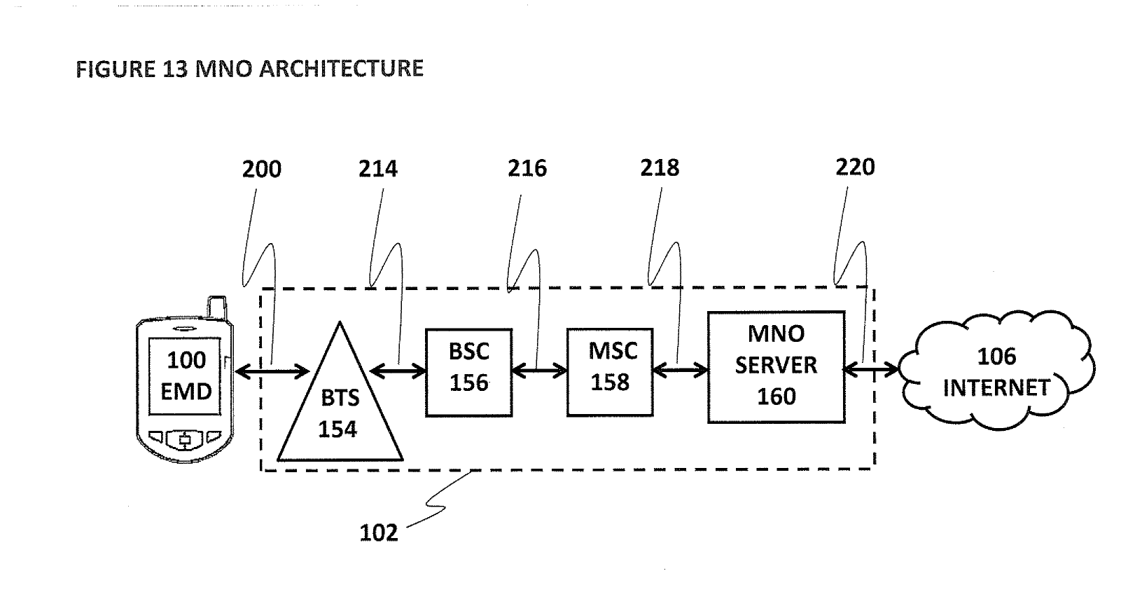

FIG. 13 is a high-level partial block diagram of an exemplary MNO including connections to an EMD and internet. Only those components germane to understanding the present invention are illustrated. EMD 100 is connected by connection 200 to MNO 102. MNO 102 includes at least one Base Transceiver Station (BTS) 154 connected by connection 214 to at least one Base Station Controller (BSC) 156 (but almost always many BTSs 154 and BSCs 156) connected by connection 216 to at least one Mobile Switching Center (MSC) 158 (only one BTS 154, BSC 156 and MSC 158 are shown in the figure for illustrational clarity). MSC 158 is connected by connection 218 to a MNO server 160. BTS 154, as is known in the art, facilitates wireless communication of EMD 100 to BSC 156. BSC 156 controls BTS 154 and connects EMD communications to MSC 158. MSC 158 carries out call switching and mobility management functions for mobile phones roaming on the network of base stations. MSC 158 is connected to an MNO server 160 of the invention. MNO server 160 is connected to the internet 106. Although FIG. 13 illustrates one EMD, one BTS, one BSC and one MSC, MNOs including MNO 102 of the invention, as is well known in the art, can comprise a network of such components to provide cellular services over a wide area.

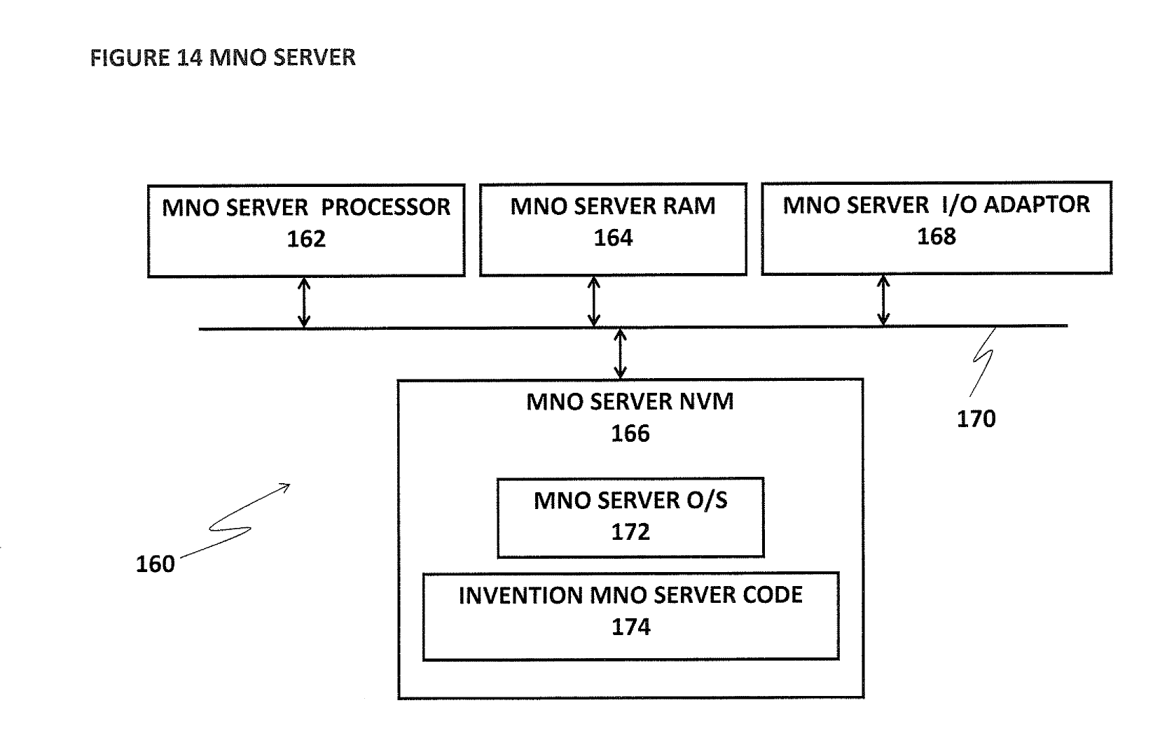

FIG. 14 is a high-level partial block diagram of an exemplary MNO server of the invention. Only components of MNO server 160 that are germane to the present invention are shown in FIG. 12. MNO server 160 includes a MNO server processor 162, a MNO server random access memory (RAM) 164, a MNO server non-volatile memory (NVM) 166 and a MNO server input/output (I/O) adaptor 168, all communicating with each other via a common bus 170. In MNO server NVM 166 are stored MNO server operating system (O/S) 172 and invention MNO server code of the present invention 174. Invention MNO server code 174 includes MNO functionality described above, for example sending communication requests (e.g. “Authenticate Outbound Call” request) in response to receiving a communication initiation from an EMD or an EC and sending the communication to the enterprise (either by DID or by providing a MSRN to the ECS) in response to receiving a communication authentication. Under the control of MNO server O/S 172, MNO server processor 172 loads invention MNO server code 174 from MNO server NVM 166 into MNO server RAM 164 at boot time and executes invention MNO server code 174 in MNO server RAM for interactions with the EMD and the internet. which interface with MNO server through I/O adaptor 168.

The above-described embodiments of the present invention are intended to be examples only. Alterations, modifications and variations can be made by those of skill in the art to the particular embodiments described without departing from the scope of the invention. For example, a different interface and configuration to that described can be implemented between the ECS and the ERS, such as port mirroring. If port mirroring between the ECS and ERS is implemented, the ECS will not be required to conference the ERS as the enterprise recording system will be able to record calls based on an enterprise managed switch that supports port mirroring.

While the invention has been described with respect to a limited number of embodiments, it will be appreciated that many variations, modifications and other applications of the invention may be made. Therefore, the claimed invention as recited in the claims that follow is not limited to the embodiments described herein.

What is claimed is:

1. A communication system which provides recording services for communications to or from at least one Enterprise Mobile Device (EMD), the system comprising:
(a) an Enterprise Compliance Server (ECS); and
(b) an Enterprise Recording System (ERS);
wherein said ECS is operative to receive a EMD communication request through a signaling channel from a Mobile Network Operator (MNO) upon MNO receipt of an EMD communication initiation;
wherein upon said receipt of said EMD communication request said ECS is operative to authenticate said EMD communication request;
wherein upon said authentication said ECS is operative to receive an EMD communication;
wherein said ECS is operative to send said EMD communication to said ERS;
wherein said ERS is operative to record said communication.

2. The communication system of claim 1, wherein said signaling channel is a secure signaling channel wherein said ECS is operative to receive said EMD communication request through an ECS input/output port by a communication protocol from said MNO via said secure signaling channel.

3. The communication system of claim 1 further comprising a Private Branch Exchange (PBX);
wherein if said EMD communication is a voice call then said receipt of said EMD communication is through said PBX.

4. The communication system of claim 1; wherein if said EMD communication is an outgoing voice call via a direct dialing communications protocol then:
(i) upon said ECS receipt of said EMD communication request said ECS is operative to authenticate said communication request by sending said MNO an enterprise telephone number through said signaling channel;
(ii) said ECS is operative to receive said EMD communication from said MNO by answering a call to said enterprise telephone number; and
(iii) said ECS is operative to connect said EMD communication to an Enterprise Customer (EC) by conferencing an EC number.

5. The communication system of claim 4 further comprising a Private Branch Exchange (PBX);
wherein said enterprise telephone number is a Direct Inward Dialing (DID) number;
wherein said ECS is operative to receive said EMD communication via DID to said Private Branch Exchange (PBX);
wherein said connection of said EMD communication to said EC is through said PBX.

6. The communication system of claim 1 wherein if said EMD communication is one of: an outgoing call in a call-back mode or an incoming call then:
(i) upon said ECS receipt of said EMD communication request said ECS is operative to authenticate and receive said EMD communication via conferencing an EMD number; and
(ii) said ECS is operative to connect said EMD communication to an Enterprise Customer (EC) by dialing an EC number.

7. The communication system of claim 6 further comprising a Private Branch Exchange (PBX) wherein said dialing of said EMD number is through said PBX;
wherein said dialing of said EC number is through said PBX.

8. The communication system of claim 1 wherein if said EMD communication is one of: a text message or an EMD data communication then:
(i) said ECS is operative to receive said EMD communication through said signaling channel.

9. The communication system according to claim 1 wherein said ECS is operative to receive a metadatum from said MNO through said signaling channel and said ECS is operative to send said metadatum associated with said EMD communication to said ERS;
wherein said ERS is operative to record said metadatum with said EMD communication.

10. The communication system according to claim 1 wherein said ECS further comprises:
(c) a policy manager;
wherein said policy manager is operative to check if said EMD communication is from a number on a white-list;
wherein said policy manager is operative to check if said EMD communication is to a number on a white-list;
wherein if said EMD communication is not from and not to a number on said white-list said ERS is operative to record said communication.

11. A Mobile Network Operator (MNO) which provides communication services to at least one Enterprise Mobile Device (EMD) wherein in response to receipt of an EMD communication initiation said MNO is operative to recognize that said communication initiation is from an EMD;
wherein in response to said recognition said MNO is operative to send a communication request through a signaling channel to an enterprise;
wherein in response to receipt of an authentication of said communication request said MNO is operative to send an EMD communication to said enterprise.

12. The MNO of claim 11 wherein said communication initiation is a via Signaling System 7 (SS7) protocol.

13. The MNO of claim 11 wherein if said EMD communication is an outgoing voice call via a direct dialing communications protocol then:
(i) said authentication of said communication request comprises an enterprise telephone number; and
(ii) said sending of said EMD communication to said enterprise is by connecting said EMD voice call to said enterprise telephone number.

14. The MNO of claim 11 wherein if said EMD communication is one of: an outgoing call in a call-back mode or an incoming call then:
(i) said MNO is operative to send said EMD communication to said enterprise by connecting a call from said enterprise to said EMD.

15. The MNO of claim 11 wherein if said. EMD communication is one of: a text message or an EMD data communication then:
(i) said MNO is operative to send said EMD communication to said enterprise through said signaling channel.

16. A communication services method for an enterprise the method comprising the steps of:
(a) receiving an Enterprise Mobile Device (EMD) communication request through a signaling channel;
(b) authenticating said communication request;
(c) in response to said authenticating, receiving an EMD communication.

17. The method of claim 16 wherein if said EMD communication is a voice call said method further comprising the steps of:
(d) connecting said EMD communication to an Enterprise Customer (EC).
(e) recording said EMD communication with an associated metadatum.

18. The method of claim 17 wherein if said EMD communication is an outgoing voice call via a direct dialing communications protocol:
(i) said receiving of said EMD communication is by Direct Inward Dialing via a PBX; and
(ii) said connecting of said EMD communication to said EC is via said PBX.

19. The method of claim 17 wherein if said EMD communication is one of: an outgoing call in a call-back mode or an incoming call then:
(i) said authenticating and said receiving of said EMD communication is via dialing a EMD number; and
(ii) said connecting of said EMD communication to said EC is via said PBX.

20. The method of claim 16 wherein if said EMD communication is one of: a text message or a EMD data communication:
(i) said receiving of said EMD communication is through said signaling channel.
